(19) United States
(12) Patent Application Publication
(10) Pub. No.: US 2024/0378554 A1
(43) Pub. Date: Nov. 14, 2024

(54) DESIGN AUTOMATION APPARATUS, DESIGN AUTOMATION SYSTEM, AND DESIGN AUTOMATION METHOD

(71) Applicant: Mitsubishi Electric Corporation, Tokyo (JP)

(72) Inventor: Daisuke OSAGAWA, Tokyo (JP)

(73) Assignee: Mitsubishi Electric Corporation, Tokyo (JP)

(21) Appl. No.: 18/779,827

(22) Filed: Jul. 22, 2024

Related U.S. Application Data
(63) Continuation of application No. PCT/JP2022/010141, filed on Mar. 8, 2022.

(51) Int. Cl. G06Q 10/087; G06Q 10/083

(52) U.S. Cl. CPC G06Q 10/087; G06Q 10/083

(57) ABSTRACT

A line candidate derivation unit (130) refers to a product database and a manufacturing device database (230) to derive a line candidate that realizes a manufacturing flow. A supplier candidate derivation unit (150) refers to the product database, a supplier database (250), and a delivery destination database to derive a supplier candidate that is close to a delivery destination. A property candidate derivation unit (160) refers to the delivery destination database and a real estate database (260) to derive a property candidate that is close to the delivery destination and the supplier candidate. An information output unit (170) outputs information on a candidate set.

### CROSS-REFERENCE TO RELATED APPLICATION

This application is a Continuation of PCT International Application No. PCT/JP2022/010141, filed on Mar. 8, 2022, which is hereby expressly incorporated by reference into the present application.

### TECHNICAL FIELD

The present disclosure relates to the design of a factory.

### BACKGROUND ART

In the design of a factory including the design of a supply chain, it is necessary to consider a wide range of factors such as a supplier, a location of the factory, selection of a device, a layout of a building, procurement of resources (human resources, electricity, water, and the like), and a delivery method. Then, it is necessary to evaluate feasibility and costs.

Therefore, the design of the factory is extremely complicated.

Conventionally, these tasks have been performed manually. Therefore, consideration that covers all patterns has been difficult and it has been hard to realize optimization of the design.

Patent Literature 1 discloses an efficiency technique for designing a factory. Specifically, a technique for deriving a layout design of the factory based on a manufacturing flow is disclosed.

This technique only performs the layout design of the factory interior. Therefore, it is not possible to perform the layout design in consideration of a property where the factory will be located and a supplier of a material.

### CITATION LIST

### Patent Literature

Patent Literature 1: JP H10-040272 A

### SUMMARY OF INVENTION

### Technical Problem

The present disclosure aims to make it possible to design a factory in consideration of a property where the factory will be located and a supplier of a material.

### Solution to Problem

A design automation apparatus of the present disclosure includes:
a line candidate derivation unit to refer to a product database that stores product information including information indicating a manufacturing flow of a product and information indicating a material used in the manufacturing flow, and a manufacturing device database that stores manufacturing device information including information indicating a function of each manufacturing device, to derive as a line candidate, a combination of manufacturing devices that realizes one or more tasks included in the manufacturing flow;
a supplier candidate derivation unit to refer to the product database, a supplier database that stores supplier information including information indicating each supplier of a material, and a delivery destination database that stores delivery destination information including information indicating a delivery destination of the product, to derive as a supplier candidate, a supplier that is close to the delivery destination;
a property candidate derivation unit to refer to the delivery destination database and a real estate database that stores real estate information indicating each property, to derive as a property candidate, a property that is close to the delivery destination and the supplier candidate; and
an information output unit to output information on a candidate set which is a set of the line candidate, the supplier candidate, and the property candidate.

### Advantageous Effects of Invention

According to the present disclosure, it is possible to design a factory in consideration of a property where the factory will be located and a supplier of a material.

### BRIEF DESCRIPTION OF DRAWINGS

FIG. 1 is an overview diagram of a design automation system 100 according to Embodiment 1.

FIG. 2 is a configuration diagram of the design automation system 100 according to Embodiment 1.

FIG. 3 is a configuration diagram of a storage unit 190 according to Embodiment 1.

FIG. 4 is a configuration diagram of a product DB 210 according to Embodiment 1.

FIG. 5 is a configuration diagram of a delivery destination DB 220 according to Embodiment 1.

FIG. 6 is a configuration diagram of a manufacturing device DB 230 according to Embodiment 1.

FIG. 7 is a configuration diagram of a carrier device DB 240 according to Embodiment 1.

FIG. 8 is a configuration diagram of a supplier DB 250 according to Embodiment 1.

FIG. 9 is a configuration diagram of a real estate DB 260 according to Embodiment 1

FIG. 10 is a configuration diagram of a transportation DB 270 according to Embodiment 1.

FIG. 11 is a configuration diagram of a design automation method according to Embodiment 1.

FIG. 12 is a flowchart of step S130 according to Embodiment 1.

FIG. 13 is a diagram illustrating an example of a line candidate according to Embodiment 1.

FIG. 14 is a diagram illustrating an example of arrangement of a delivery destination and suppliers according to Embodiment 1.

FIG. 15 is a diagram illustrating an example of arrangement of a logistics center of gravity and properties according to Embodiment 1.

FIG. 16 is a flowchart of step S170 according to Embodiment 1.

FIG. 17 is a hardware configuration diagram of the design automation system 100 according to Embodiment 1.

### DESCRIPTION OF EMBODIMENTS

In the embodiments and drawings, the same elements or corresponding elements are denoted by the same reference sign. Description of an element denoted by the same reference sign as that of an element that has been described will be suitably omitted or simplified. Arrows in the diagrams mainly indicate flows of data or flows of processes.

### Embodiment 1

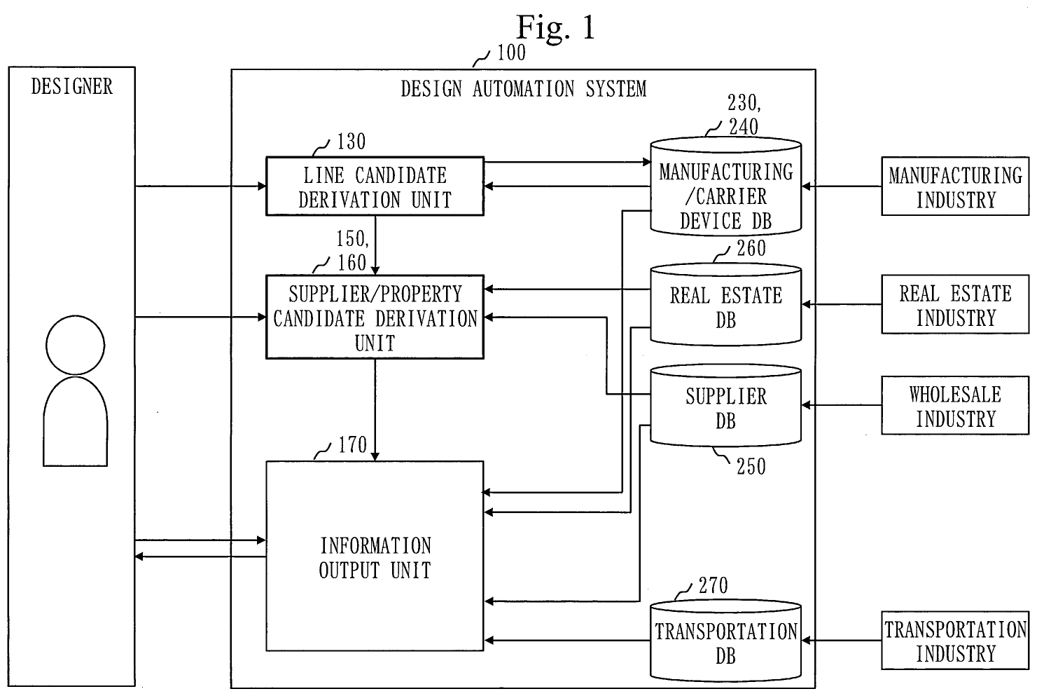

A design automation system 100 will be described based on FIGS. 1 to 17.

### Description of Overview

FIG. 1 illustrates an overview of the design automation system 100.

The design automation system 100 derives a line candidate for manufacturing a product, a supplier candidate for purchasing a material, and a property candidate for locating the line candidate, based on various information.

Device information obtained from a system of the manufacturing industry, real estate information obtained from a system of the real estate industry, supplier information obtained from a system of the wholesale industry, transportation information obtained from a system of the transportation industry, and the like are used, for example.

Then, the design automation system 100 presents the derived candidates to a designer.

### Description of Configuration

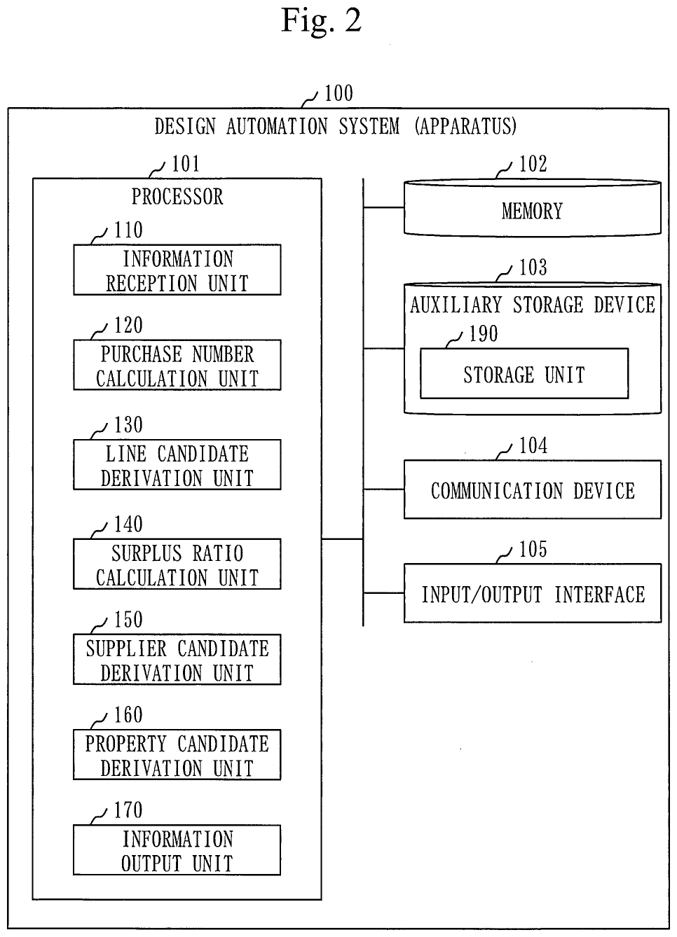

A configuration of the design automation system 100 will be described based on FIG. 2.

The design automation system 100 is a computer that includes pieces of hardware such as a processor 101, a memory 102, an auxiliary storage device 103, a communication device 104, and an input/output interface 105. These pieces of hardware are connected with one another through signal lines.

The design automation system 100 may also be called a design automation apparatus.

The processor 101 is an IC that performs arithmetic processing and controls other pieces of hardware. The processor 101 is, for example, a CPU.

IC is an abbreviation for Integrated Circuit.

CPU is an abbreviation for Central Processing Unit.

The memory 102 is a volatile or non-volatile storage device. The memory 102 is also called a main storage device or a main memory. The memory 102 is, for example, an RAM. Data stored in the memory 102 is saved in the auxiliary storage device 103 as necessary.

RAM is an abbreviation for Random Access Memory.

The auxiliary storage device 103 is a non-volatile storage device. The auxiliary storage device 103 is, for example, an ROM, an HDD, a flash memory, or a combination thereof. Data stored in the auxiliary storage device 103 is loaded into the memory 102 as necessary.

ROM is an abbreviation for Read Only Memory.

HDD is an abbreviation for Hard Disk Drive.

The communication device 104 is a receiver and a transmitter. The communication device 104 is, for example, a communication chip or an NIC. Communication of the design automation system 100 is performed using the communication device 104.

NIC is an abbreviation for Network Interface Card.

The input/output interface 105 is a port to which an input device and an output device are connected. The input/output interface 105 is a USB terminal, the input device is a keyboard and a mouse, and the output device is a display, for example. Input/output of the design automation system 100 is performed, using the input/output interface 105.

USB is an abbreviation for Universal Serial Bus.

The design automation system 100 includes elements such as an information reception unit 110, a purchase number calculation unit 120, a line candidate derivation unit 130, a surplus ratio calculation unit 140, a supplier candidate derivation unit 150, a property candidate derivation unit 160, and an information output unit 170. These elements are realized by software.

The auxiliary storage device 103 stores a design automation program that causes a computer to function as the information reception unit 110, the purchase number calculation unit 120, the line candidate derivation unit 130, the surplus ratio calculation unit 140, the supplier candidate derivation unit 150, the property candidate derivation unit 160, and the information output unit 170. The design automation program is loaded into the memory 102 and executed by the processor 101.

The auxiliary storage device 103 further stores an OS. At least a part of the OS is loaded into the memory 102 and executed by the processor 101.

The processor 101 executes the design automation program while executing the OS.

OS is an abbreviation for Operating System.

A storage unit 190 stores input/output data of the design automation program.

The auxiliary storage device 103 functions as the storage unit 190. However, a storage device such as the memory 102, a register in the processor 101, and a cache memory in the processor 101 may function as the storage unit 190 in place of the memory 102 or together with the memory 102.

The design automation system 100 may include a plurality of processors as an alternative to the processor 101.

The design automation program can be recorded (stored) in a computer readable format in a non-volatile recording medium such as an optical disc or a flash memory.

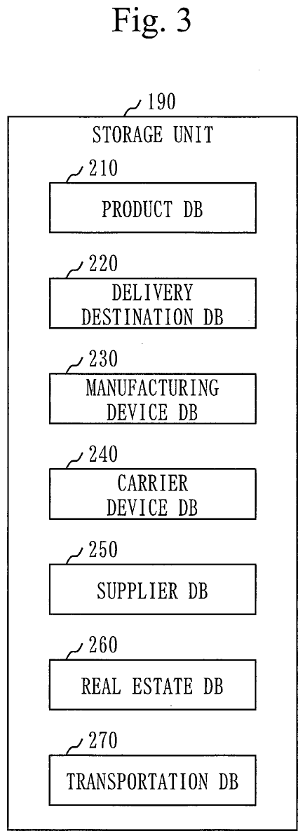

A configuration of the storage unit 190 will be described based on FIG. 3.

The storage unit 190 stores various databases (DBs).

Specifically, a product DB 210, a delivery destination DB 220, a manufacturing device DB 230, a carrier device DB 240, a supplier DB 250, a real estate DB 260, and a transportation DB 270 are stored.

The product DB 210 stores product information. The product information is information relating to an article (a product) to be manufactured.

The delivery destination DB 220 stores delivery destination information. The delivery destination information is information relating to a delivery destination of the product.

The manufacturing device DB 230 stores manufacturing device information. The manufacturing device information is information relating to a device (a manufacturing device) used for the manufacture of the product.

The carrier device DB 240 stores carrier device information. The carrier device information is information relating to a device (a carrier device) used for carrying an object in the manufacture of the product.

The supplier DB 250 stores supplier information. The supplier information is information relating to a supplier of a material used for the manufacture of the product.

The real estate DB 260 stores real estate information. The real estate information is information relating to a property for locating a factory of the product.

The transportation DB 270 stores transportation information. The transportation information is information relating to transportation for the product or the material.

Each of the product information and the delivery destination information is input by the designer and stored in the database, for example.

Each of the manufacturing device information, the carrier device information, the supplier information, the real estate information, and the transportation information is stored in the database in advance, for example. Alternatively, these pieces of information are stored in the databases of the design automation system 100 from a database published on a network (for example, the Internet).

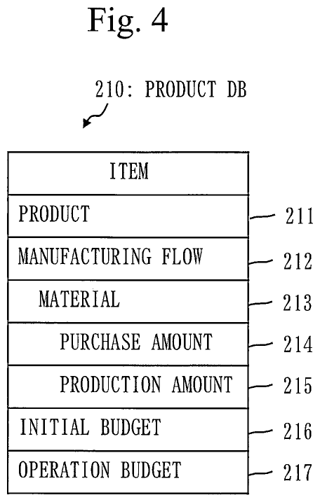

A configuration of the product DB 210 will be described based on FIG. 4.

The product DB 210 shows information such as a product 211, a manufacturing flow 212, a material 213, a purchase amount 214, a production amount 215, an initial budget 216, and an operation budget 217.

The product 211 indicates a product. The product 211 is, for example, a product name. The product name identifies a type of the product 211.

The manufacturing flow 212 indicates a task order for manufacturing the product. The task order is an order of one or more tasks. A manufacturing flow is also referred to as a manufacturing procedure.

The material 213 indicates for each task, a material used in a task. The material 213 is, for example, a material name.

The purchase amount 214 is the purchase number of materials necessary for one product.

The production amount 215 indicates the necessary production number of materials per unit time.

The initial budget 216 is a budget that can be paid before the manufacture of the product.

The operation budget 217 is a budget that can be spent on one product.

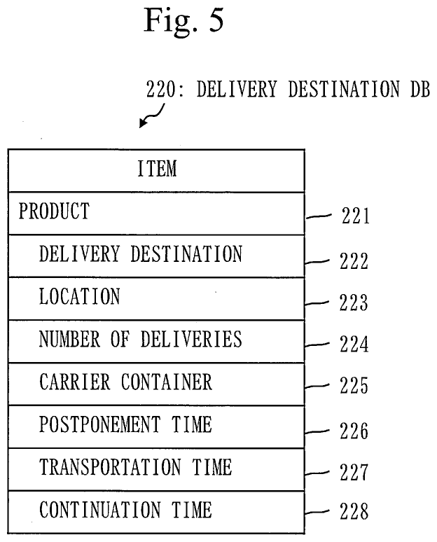

A configuration of the delivery destination DB 220 will be described based on FIG. 5.

The delivery destination DB 220 shows information such as a product 221, a delivery destination 222, a location 223, a number of deliveries 224, a carrier container 225, a postponement time 226, a transportation time 227, and a continuation time 228.

The product 221 indicates a product to be delivered. The product 221 is, for example, a product name. The product name identifies a type of the product 221. The product 221 is associated with the product 211.

The delivery destination 222 indicates a delivery destination of the product. The delivery destination 222 is, for example, a delivery destination name.

The location 223 is a location of the delivery destination.

The number of deliveries 224 is the number of deliveries per unit time.

The carrier container 225 is a carrier container of the product at a time of delivery. The carrier container is a container used for carrying. A specific example of the carrier container is a shipping container.

The postponement time 226 is a time postponed until the delivery starts.

The transportation time 227 is a transportation time at the time of the delivery. The transportation time is a time that can be spent on transportation.

The continuation time 228 is a continuation time of the delivery. The continuation time is a time for operation to be continuous.

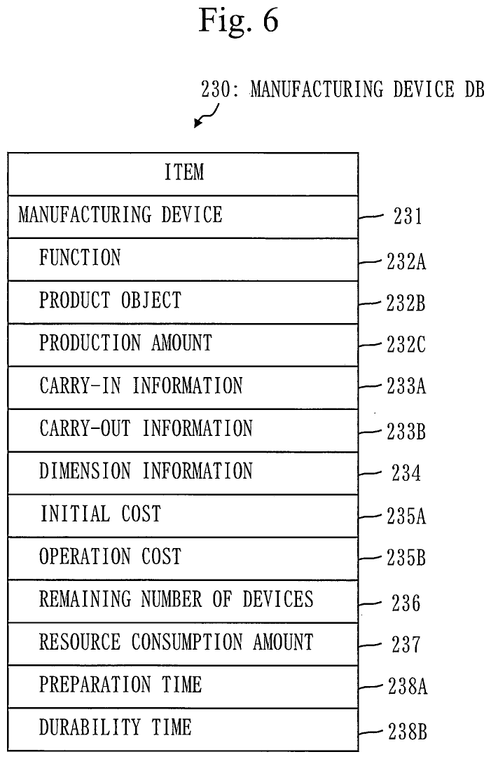

A configuration of the manufacturing device DB 230 will be described based on FIG. 6.

The manufacturing device DB 230 shows information such as a manufacturing device 231, a function 232A, a product object 232B, a production amount 232C, carry-in information 233A, carry-out information 233B, and dimension information 234. Further, the manufacturing device DB 230 shows information such as an initial cost 235A, an operation cost 235B, a remaining number of devices 236, a resource consumption amount 237, a preparation time 238A, and a durability time 238B.

The manufacturing device 231 indicates a manufacturing device. The manufacturing device 231 is, for example, a manufacturing device name. The manufacturing device name identifies a type of the manufacturing device 231.

The function 232A is a function realized by the manufacturing device. The function 232A is associated with the tasks in the manufacturing flow 212.

The product object 232B is a product object of the manufacturing device. The product object is an object that is produced and output.

The production amount 232C is the maximum production amount per unit time by the manufacturing device. The production amount is the number of product objects.

The carry-in information 233A is carry-in information on an upstream object to the manufacturing device. The upstream object is an object that is input from the manufacturing device at the upstream or the carrier device at the upstream. The carry-in information indicates a carry-in method and a carrier container. The carry-in method is a method used for carry-in. Specific examples of the carry-in method are a conveyor and a manual delivery.

The carry-out information 233B is carry-out information on the product object from the manufacturing device. The carry-out information indicates a carry-out method and a carrier container. The carry-out method is a method used for carry-out. Specific examples of the carry-out method are a conveyor and a manual delivery.

The dimension information 234 indicates a size of the manufacturing device and a weight of the manufacturing device. Information indicating the size includes a floor area.

The initial cost 255A is a cost necessary for the derivation of the manufacturing device.

The operation cost 235B is an operation cost of the manufacturing device per product. The operation cost is a cost that is incurred regularly.

The remaining number of devices 236 is the remaining number of manufacturing devices. The remaining number of devices is the number of devices that can be installed in any property, among the number of owned devices.

The resource consumption amount 237 is an amount of resources necessary for production of the product object for one product. The product object for one product means that an object necessary for manufacturing the one product. Specific examples of the resources are gas, electricity, water, and human beings.

The preparation time 238A a preparation time until start of activation of the manufacturing device. The preparation time is a necessary time.

The durability time 238B is a durability time of the manufacturing device. The durability time is a continuously operable time.

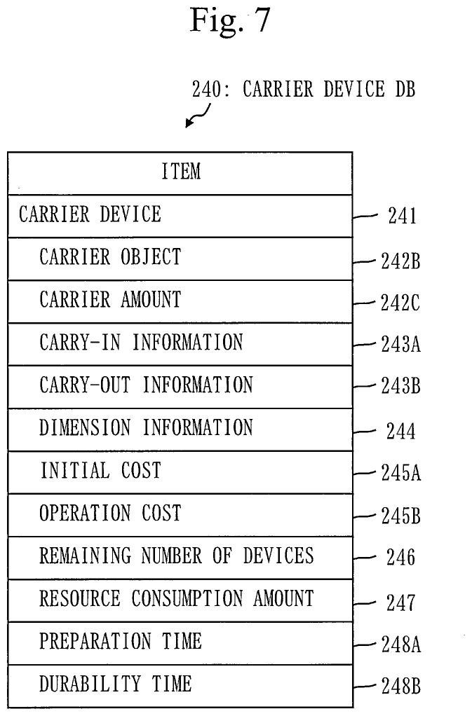

A configuration of the carrier device DB 240 will be described based on FIG. 7.

The carrier device DB 240 shows information such as a carrier device 241, a carrier object 242B, a carrier amount 242C, carry-in information 243A, carry-out information 243B, and dimension information 244. Further, the carrier device DB 240 shows information such as an initial cost 245A, an operation cost 245B, a remaining number of devices 246, a resource consumption amount 247, a preparation time 248A, and a durability time 248B.

The carrier device 241 indicates a carrier device. The carrier device 241 is, for example, a carrier device name. The carrier device name identifies a type of the carrier device 241.

The carrier object 242B indicates a carrier object of the carrier device. The carrier object 242B is, for example, a carrier object name. The carrier object is an object to be carried. The carrier object is also referred to as a work piece.

The carrier amount 242C is the maximum carrier amount per unit time by the carrier device. The carrier amount is the number of carrier objects.

The carry-in information 243A is carry-in information on an upstream object to the carrier device.

The carry-out information 243B is carry-out information on the carrier object from the carrier device.

The dimension information 244 indicates a size of the carrier device and a weight of the carrier device.

The initial cost 245A is a cost necessary for the derivation of the carrier device.

The operation cost 245B is an operation cost of the carrier device per product.

The remaining number of devices 246 is the remaining number of carrier devices.

The resource consumption amount 247 is an amount of resources necessary for carrying the carrier object for one product.

The preparation time 248A is a preparation time until start of activation of the carrier device.

The durability time 248B is a durability time of the carrier device.

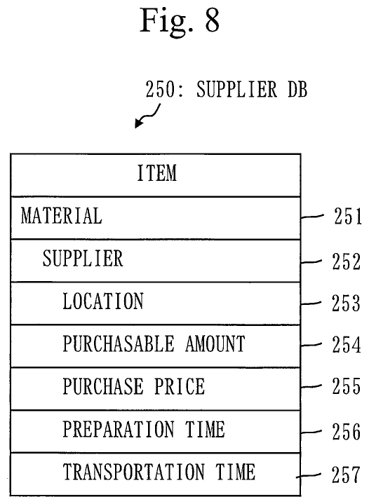

A configuration of the supplier DB 250 will be described based on FIG. 8.

The supplier DB 250 shows information such as a material 251, a supplier 252, a location 253, a purchasable amount 254, a purchase price 255, a preparation time 256, and a transportation time 257.

The material 251 indicates a material that can be purchased. The material 251 is, for example, a material name. The material 251 is associated with the material 213.

The supplier 252 indicates a supplier. The supplier 252 is, for example, a supplier name.

The location 253 is a location of the supplier.

The purchasable amount 254 is a purchasable amount per unit time from the supplier. The purchasable amount is the number of materials that can be purchased.

The purchase price 255 indicates a purchase price from the supplier. The purchase price is an amount of money spent on the purchase of the materials.

The preparation time 256 is a preparation time until start of the purchase.

The transportation time 257 is a transportation time at a time of the purchase.

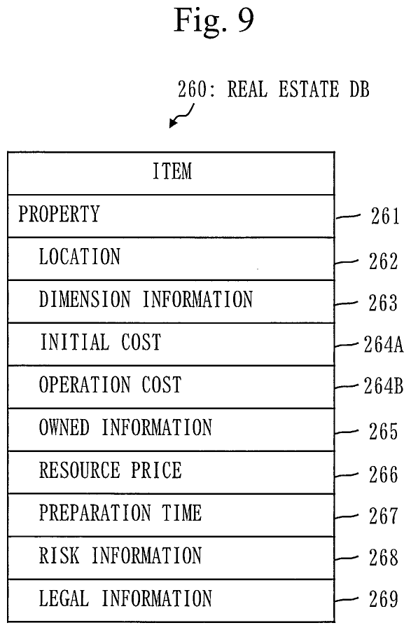

A configuration of the real estate DB 260 will be described based on FIG. 9.

The real estate DB 260 shows information such as a property 261, a location 262, and dimension information 263. Further, the real estate DB 260 shows information such as an initial cost 264A, an operation cost 264B, owned information 265, a resource price 266, and a preparation time 267. Further, the real estate DB 260 indicates information such as risk information 268 and legal information 269.

The property 261 indicates a property. The property 261 is, for example, a property name.

The location 262 is a location of the property.

The dimension information 263 indicates dimension information on the property. Specifically, the dimension information 263 indicates an area of a land, a floor area of a building, a width of a doorway, a height of the doorway, a constraint of a weight, and the like.

The initial cost 264A is a cost necessary for obtainment of the property.

The operation cost 264B is an operation cost of the property per product.

The owned information 265 indicates whether or not the property is owned.

The resource price 266 is a price of a resource at the location of the property.

The preparation time 267 is a preparation time until start of use of the property.

The risk information 268 indicates a risk relating to the location of the property. Specific risks are a geopolitical risk and a natural disaster risk.

The legal information 269 indicates matters applied to the property based on lows and regulations. The legal information 269 indicates, for example, various preferential measures, restrictions during construction, restrictions during manufacturing, and the like.

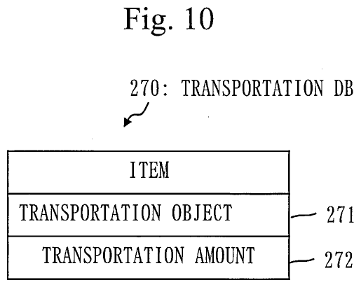

A configuration of the transportation DB 270 will be described based on FIG. 10.

The transportation DB 270 indicates information such as a transportation object 271 and a transportation amount 272.

The transportation object 271 indicates an object (a transportation object) to be transported. The transportation object 271 is, for example, a transportation name. The transportation object 271 is associated with the product 211 or the material 213.

The transportation amount 272 is the number of transportation objects that can be transported in one transportation. A unit of the transportation amount 272 is, for example, the number of containers.

### Description of Operation

A procedure of operation of the design automation system 100 is equivalent to a design automation method. Further, the procedure of the operation of the design automation system 100 is equivalent to a procedure of processing by the design automation program.

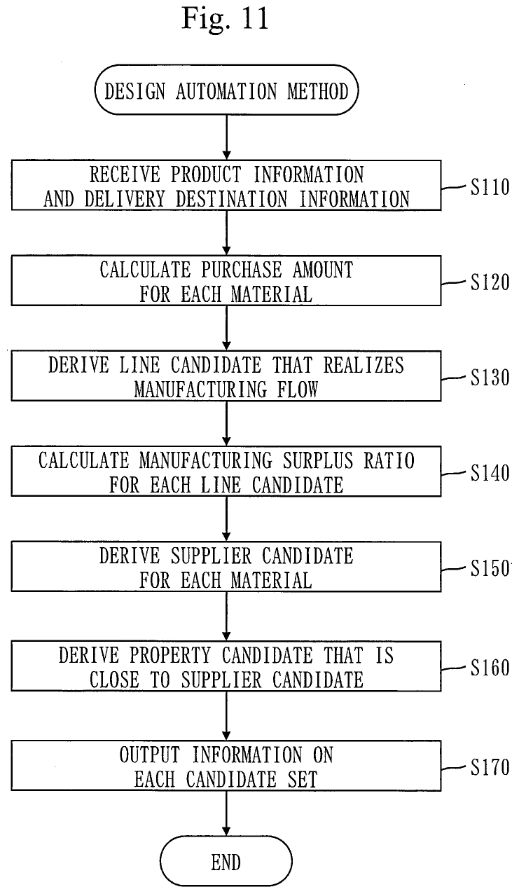

The design automation method with be described based on FIG. 11.

In step S110, the designer inputs the product information into the design automation system 100.

The information reception unit 110 receives the product information, and stores the product information into the product DB 210.

Further, the designer inputs the delivery destination information into the design automation system 100.

The information reception unit 110 receives the delivery destination information, and stores the delivery destination information into the delivery destination DB 220.

However, the product information and the delivery destination information may be stored in the databases in advance. In this case, step S110 is unnecessary.

In step S120, the purchase number calculation unit 120 calculates for each material 213, a purchase amount per unit time.

The purchase amount per unit time is calculated by calculating the following formula, using the purchase amount 214 and the number of deliveries 224.

$$PA = [ 214 ] \times [ 224 ]$$

“PA” is the purchase amount per unit time.
[214] is the purchase amount 214.
[224] is the number of deliveries 224.

In step S130, the line candidate derivation unit 130 derives a line candidate that can realize the manufacturing flow 212.

The line candidate is a candidate of a manufacturing line.

The manufacturing line is a combination of manufacturing devices and carrier devices. On the manufacturing line, the manufacturing devices and the carrier devices are arranged in order of tasks.

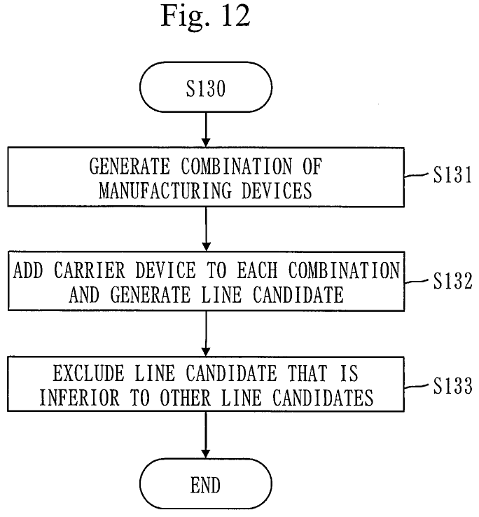

A procedure of step S130 will be described based on FIG. 12.

In step S131, the line candidate derivation unit 130 generates a combination of manufacturing devices 231 that realizes one or more tasks included in the manufacturing flow 212.

Each of the manufacturing devices 231 has the function 232A that realizes one task or a plurality of consecutive tasks.

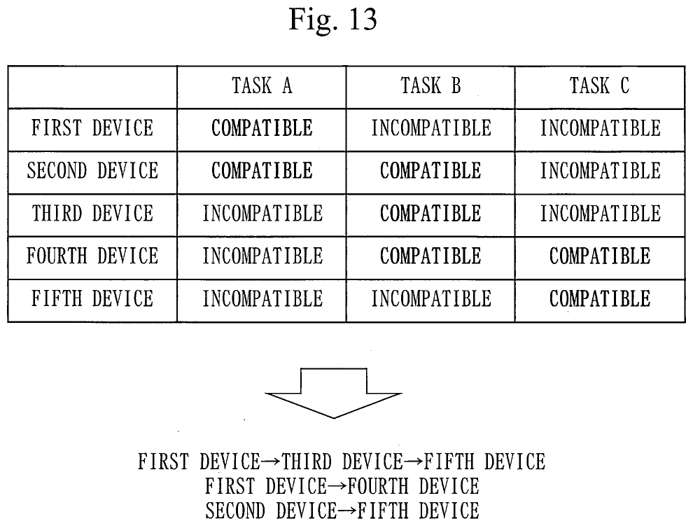

An example of the combination of manufacturing devices derived as the line candidate will be described based on FIG. 13. Each of a first device to a fifth device is a manufacturing device. “Compatible” means that the manufacturing device has a function that realizes a task. “Incompatible” means that the manufacturing device does not have a function that realizes a task.

The manufacturing flow 212 is a flow of a task A, a task B, and a task C. In this case, three combinations are derived.

A first combination is the first device, the third device, and the fifth device.

A second combination is the first device and the fourth device.

A third combination is the second device and the fifth device.

Each of the combinations realizes the task A, the task B, and the task C.

Returning to FIG. 12, the description of step S131 will be continued.

Each of the combinations of manufacturing devices 231 is generated as follows.

First, the line candidate derivation unit 130 selects the manufacturing device 231 having the function 232A that realizes the most upstream task on the manufacturing flow 212.

Then, the line candidate derivation unit 130 selects for each of the second and following tasks on the manufacturing flow 212, the manufacturing device 231 having the function 232A that realizes the next task after the task for which the manufacturing device 231 has been selected.

The line candidate derivation unit 130 may not select a new manufacturing device 231 for the task to be realized by the selected manufacturing device 231.

The line candidate derivation unit 130 may consider the preparation time 238A of each manufacturing device 231 and the postponement time 226 of the product 221.

In this case, the preparation time 238A of each manufacturing device 231 is less than or equal to the postponement time 226.

When the production amount 232C of the selected manufacturing device 231 does not satisfy the production amount 215 of the material 213, the line candidate derivation unit 130 increases the number of selected manufacturing devices 231.

The number of manufacturing devices 231 is the minimum N that satisfies the following formula.

$$[ 232 C ] \times N \geq [ 215 ]$$

[232C] is the production amount 232C.
[215] is the production amount 215.

When the manufacturing device 231 of the same type as the selected manufacturing device 231 is being used for another manufacturing, the manufacturing device 231 being used can be used.

In this case, the line candidate derivation unit 130 subtracts from the production amount 232C of the selected manufacturing device 231, the number of product objects that has been produced by the manufacturing device 231 being used. The amount to be subtracted is written as “M”.

In step S132, the line candidate derivation unit 130 selects a necessary carrier device 241 for each combination of manufacturing devices 231, and adds the selected carrier device 241.

When the carry-out information 233B on the manufacturing device 231 at the upstream does not consistent with the carry-in information 233A on the manufacturing device 231 at the downstream, the carrier device 241 is necessary between the manufacturing devices 231.

The carrier device 241 to be selected satisfies all of formulas (1) to (5).

[242B]⊇[232B] at the upstream (1)

[242C]≥[232C] at the upstream (2)

[243A]=[233B] at the upstream (3)

[243B]=[233A] at the downstream (4)

[248A]≤[242B] (5)
[242B] is the carrier object 242B.
[232B] is the product object 232B.
[242C] is the carrier amount 242C.
[232C] is the production amount 232C.
[243A] is the carry-in information 243A.
[233B] is the carry-out information 233B.
[243B] is the carry-out information 243B.
[233A] is the carry-in information 233A.
[248A] is the preparation time 248A.
[226] is the postponement time 226.

However, the formula (4) is replaced with the following formula for the most downstream task.

[243B]=[225]
[225] is the carrier container 225.

Each combination obtained in step S132 is the line candidate.

In step S133, the line candidate derivation unit 130 calculates for each line candidate, the total sum of comparison factors of each manufacturing device 231 and comparison factors of each carrier device 241.

Next, the line candidate derivation unit 130 compares the total sums of comparison factors between line candidates.

Then, the line candidate derivation unit 130 excludes a line candidate whose total sum of comparison factors is inferior to those of other line candidates.

Specifically, the comparison factors are a dimension, an initial cost, an operation cost, and a resource consumption amount.

The total sum of dimensions is calculated by summing the dimension information 234 on each manufacturing device 231 and the dimension information 244 on each carrier device 241.

The total sum of initial costs is calculated by summing the initial cost 255A of each manufacturing device 231 and the initial cost 245A of each carrier device 241.

The total sum of operation costs is calculated by summing the operation cost 235B of each manufacturing device 231 and the operation cost 245B of each carrier device 241.

The total sum of resource consumption amounts is calculated by summing the resource consumption amount 237 of each manufacturing device 231 and the resource consumption amount 247 of each carrier device 241.

Then, the line candidate derivation unit 130 excludes a line candidate whose total sums are the most inferior in all of comparison factors.

That is, the line candidate to be excluded is a line candidate whose total sum of dimensions is the largest, total sum of initial cost is the highest, total sum of operation costs is highest, and total sum of resource consumption amounts is largest.

When there is no corresponding line candidate, none of line candidates are excluded.

However, at least one of the dimension, the initial cost, the operation cost, and the resource consumption amount may be omitted from the comparison factors. The resource consumption amount may be omitted from the comparison factors, for example. The line candidate to be excluded has the total sum of dimensions, the total sum of initial costs, and the total sum of operation costs, all of which is the most inferior.

Alternatively, the line candidate derivation unit 130 may exclude a line candidate whose total sum is the most inferior in at least one of the dimension, the initial cost, the operation cost, and the resource consumption amount. The line candidate derivation unit 130 excludes a line candidate whose total sum of dimensions is the most inferior, a line candidate whose total sum of initial costs is the most inferior, a line candidate whose total sum of operation costs is the most inferior, and a line candidate whose total sum of resource consumption amounts is the most inferior, for example.

Returning to FIG. 11, the description will be continued from step S140.

In step S140, the surplus ratio calculation unit 140 calculates a manufacturing surplus ratio for each line candidate.

The manufacturing surplus ratio is a ratio of a manufacturing capacity of a line candidate to a necessary manufacturing capacity.

The manufacturing surplus ratio is calculated by calculating the following formula.

SR=min{([232C]×N−M)/[215]}
“SR” is the manufacturing surplus ratio.
min {V} is the smallest value among values each of which is a value V of each manufacturing device.
[232C] is the production amount 232C.
“N” is a value calculated in step S131.
“M” is a value indicated in step S131.
[215] is the production amount 215.

The manufacturing surplus ratio is an example of comparison information to be described below.

In step S150, the supplier candidate derivation unit 150 derives a supplier candidate for each material 213.

The supplier candidate is derived as follows.

First, the supplier candidate derivation unit 150 calculates a distance from the delivery destination 222 to each supplier 252, based on the location 223 of the delivery destination 222 and the location 253 of each supplier 252.

Then, the supplier candidate derivation unit 150 selects the supplier 252 that is closest to the delivery destination 222. The selected supplier 252 is the supplier candidate.

A distance from the delivery destination 222 to the supplier 252 may be either a straight line distance or a distance along a route.

The supplier candidate derivation unit 150 may consider the postponement time 226 of the delivery destination 222 and the preparation time 256 of each supplier 252.

In this case, the supplier candidate derivation unit 150 selects a supplier candidate from among suppliers 252 whose preparation time 256 is less than or equal to the postponement time 226.

The supplier candidate derivation unit 150 may consider the purchase amount (refer to S120) of the material 213 and the purchasable amount 254 of the supplier candidate, as described below. The purchase amount of the material 213 may be calculated by the supplier candidate derivation unit 150.

The supplier candidate derivation unit 150 compares the purchasable amount 254 of the supplier candidate with the purchase amount of the material 213.

When the purchasable amount 254 is less than the purchase amount, the purchase amount 214 cannot be purchased from the supplier candidate. In this case, the supplier candidate derivation unit 150 selects one or more suppliers 232 excluding the supplier candidate, in order of proximity to the delivery destination 222. The selected one or more suppliers 252 are added to the supplier candidates. The total sum of the purchasable amount 254 of the supplier candidates is equal to or greater than the purchase amount 214.

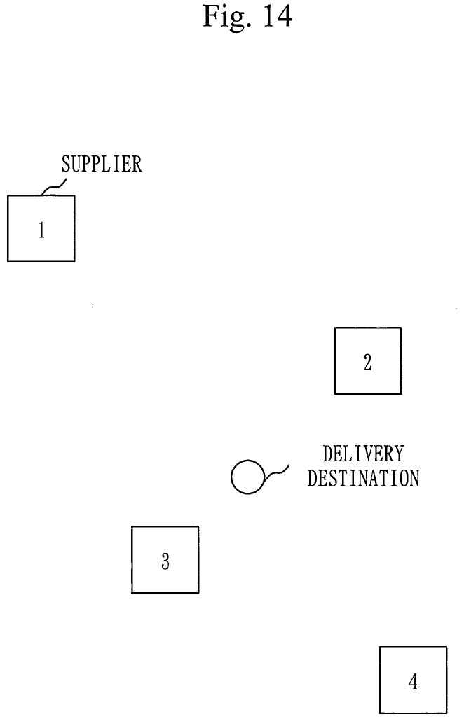

FIG. 14 indicates an example of arrangement of a delivery destination and a plurality of suppliers. A circle indicates the delivery destination. Squares indicate the suppliers. A third supplier is a supplier (a supplier candidate) that is closest to the delivery destination. The purchase amount 214 cannot be purchased from the third supplier. In this case, the supplier candidate derivation unit 150 adds one or more suppliers to supplier candidates, in order of a second supplier, a fourth supplier, and a first supplier.

Returning to FIG. 11, the description of step S150 will be continued.

When there are a plurality of delivery destinations 222, the supplier candidate derivation unit 150 calculates a point of center of gravity of the delivery destinations 222, and selects a supplier candidate based on a distance from the point of center of gravity.

In step S160, the property candidate derivation unit 160 derives a property candidate that is close to the supplier candidate of each material and the delivery destination 222.

The property candidate is the property 261 for which a transportation distance of each of the material 213 and the product 211 is short.

The property candidate is derived as follows.

First, the property candidate derivation unit 160 calculates the point of center of gravity of the supplier candidates and the delivery destination 222, based on the location 253 of each supplier candidate and the location 223 of the delivery destination 222. The calculated point of center of gravity is referred to as a logistics center of gravity.

Next, the property candidate derivation unit 160 calculates for each property 261, a distance from the property 261 to the point of center of gravity, based on the location 262 of the property 261. The calculated distance is referred to as the transportation distance.

Then, the property candidate derivation unit 160 selects the property 261 corresponding to the shortest transportation distance. The selected property 261 is the property candidate.

The distance from the property 261 to the point of center of gravity may be either a straight line distance or a distance along a route.

The property candidate derivation unit 160 may consider the postponement time 226 of the delivery destination 222 and the preparation time 267 of each property 261.

In this case, the property candidate derivation unit 160 selects the property candidate from among properties 261 whose preparation times 267 are less than or equal to the postponement time 226.

The property candidate derivation unit 160 may consider a transportation cost of each of the material 213 and the product 211.

In this case, the property candidate derivation unit 160 weights the location 253 of the supplier 252 for each material 213, based on the transportation amount 272 of the material 213. The weight is calculated by calculating the following formula, for example.

W5=MIN{[214],[254]}/[272]
“W5” is the weight.
is the purchase amount 214.
is the purchasable amount 254.

MIN {X, Y} is the smaller of a value X and a value Y. MIN {[214], [254]} means an amount purchased from the supplier 252.

Further, the property candidate derivation unit 160 weights the location 223 of the delivery destination 222, based on the transportation amount 272 of the product 211. The weight is calculated by calculating the following formula, for example.

W2=[224]/[272]
[224] is the number of deliveries 224.

The property candidate derivation unit 160 may consider the dimension information 263 of the property candidate, the dimension information 234 of each manufacturing device 231, and the dimension information 244 of each carrier device 241, as described below. In this case, the property candidate is derived for each line candidate.

The property candidate derivation unit 160 determines whether or not the line candidate can be laid out in the property candidate, based on the dimension information 263, each dimension information 234, and each dimension information 244. A layout method may be the same as the conventional method.

When the line candidate cannot be laid out in the property candidate, the property candidate derivation unit 160 selects one or more properties 261 excluding the logistics candidate, in ascending order of transportation distances. The selected one or more properties 261 are added to the logistics candidates. As a result, the line candidate can be laid out in the logistics candidates. In the layout, the manufacturing device 231 at the upstream and the carrier device 241 at the upstream are preferable to be installed in the property candidate that is as far as possible from the delivery destination 222. The manufacturing device 231 at the downstream and the carrier device 241 at the downstream are preferable to be installed in the property candidate that is as close as possible to the delivery destination 222.

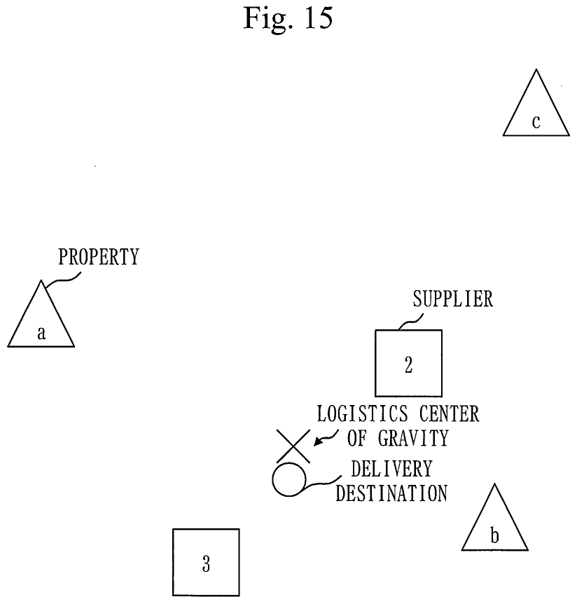

FIG. 15 illustrates an example of arrangement of the logistics center of gravity and a plurality of properties. Triangles indicate the properties. A cross mark indicates the point of center of gravity (the logistics center of gravity) of a delivery destination, a second supplier, and a third supplier. A property b is a property (a property candidate) that is closest to the logistics center of gravity. The line candidate cannot be laid out on the property b. In this case, the property candidate derivation unit 160 adds one or more properties to the property candidates, in order of a property a and a property c.

Returning to FIG. 11, step S170 will be described.

In step S170, the information output unit 170 outputs information on each candidate set.

The candidate set is a set of a line candidate, a supplier candidate, and a property candidate.

Specifically, the information output unit 170 outputs information indicating each candidate set and comparison information on each candidate set.

The comparison information is information that is refereed to for comparison between candidate sets.

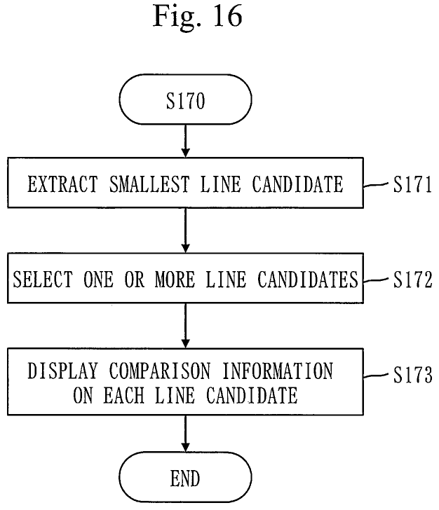

A procedure of step S170 will be described based on FIG. 16.

In step S171, the information output unit 170 selects the smallest line candidate.

The smallest line candidate is the line candidate whose necessary floor area is the smallest.

The smallest line candidate is selected as follows.

First, the information output unit 170 calculates for each line candidate, the necessary floor area, based on the dimension information 234 on each manufacturing device 231 and the dimension information 244 on each carrier device 241.

Then, the information output unit 170 selects the line candidate whose necessary floor area is the smallest. The selected line candidate is the smallest line candidate.

In step S172, the information output unit 170 selects one or more line candidates based on a cost of each candidate set.

The one or more line candidates are selected as follows.

First, the information output unit 170 selects a candidate set including the smallest line candidate. The selected candidate set is referred to as the smallest candidate set.

Next, the information output unit 170 compares a cost of each candidate set other than the smallest candidate set, with a cost of the smallest candidate set.

Then, the information output unit 170 selects a candidate set whose cost is lower than that of the smallest candidate set.

Specifically, the information output unit 170 calculates a first cost to a sixth cost for each candidate set, and selects a candidate set whose cost is lower than that of the smallest candidate set.

The first cost is a device initial cost. The device initial cost is the total sum of the initial cost 235A of each manufacturing device 231 and the initial cost 245A of each carrier device 241.

A second cost is a device operation cost. The device operation cost is the total sum of the operation cost 235B of each manufacturing device 231 and the operation cost 245B of each carrier device 241.

A third cost is a purchase cost. The purchase cost is the total sum of the purchase prices 255 of each supplier 252.

A fourth cost is a property initial cost. The property initial cost is the total sum of the initial costs 264A of each property 261.

A fifth cost is a property operation cost. The property operation cost is the total sum of the operation costs 264B of each property 261.

The sixth cost is a resource cost. The resource cost is the total sum of the resource prices 266 of each property 261.

The information output unit 170 may exclude any line candidate from one or more line candidates as described below.

The information output unit 170 excludes a line candidate that cannot transport the product 221 within the transportation time 227 of the delivery destination 222. A calculation method of the transportation time of the product 221 may be the same as the conventional method.

The information output unit 170 excludes a line candidate that cannot transport the material 251 within the transportation time 257 of the supplier 252. A calculation method of the transportation time of the material 251 may be the same as the conventional method.

The information output unit 170 calculates an initial cost for each line candidate, and excludes a line candidate whose initial cost exceeds the initial budget 216.

The initial cost is the total of the device initial cost and the property initial cost. The initial cost is an example of the comparison information to be described below.

The device initial cost is the total sum of the initial cost 235A of each manufacturing device 231 and the initial cost 245A of each carrier device 241.

The property initial cost is the total sum of the initial costs 264A of each property 261.

The information output unit 170 calculates an operation cost per product for each line candidate, and excludes a line candidate whose calculated operation cost exceeds the operation budget 217.

The operation cost per product is the total of a device operation cost, a property operation cost, a resource cost, a purchase cost, a supplier transportation cost, an inter-property transportation cost, and a delivery destination transportation cost. The operation cost per product is an example of the comparison information to be described below.

The device operation cost is the total sum of the operation cost 235B of each manufacturing device 231 and the operation cost 245B of each carrier device 241.

The property operation cost is the total sum of the operation costs 264B of each property 261.

The resource cost is the total sum of production costs of each material 251. The production cost is calculated by multiplying the resource price 266 by the resource consumption amount (237, 247) and the production amount 215.

The purchase cost is the total sum of costs of each material 251. The cost of the material 251 is calculated by multiplying the purchase price 255 by the purchase amount 214.

The supplier transportation cost is the total sum of transportation costs from each supplier 252 to the property 261, per product. A calculation method of the transportation cost may be the same as the conventional method.

The inter-property transportation cost is the total sum of the transportation costs between properties 261, per product.

The delivery destination transportation cost is the total sum of the transportation costs from each property 261 to the delivery destination 222, per product.

In step S173, the information output unit 170 displays the comparison information on each line candidate.

Specifically, the information output unit 170 displays the comparison information as described below.

The information output unit 170 displays the manufacturing surplus ratio calculated in step S140. The manufacturing surplus ratio may be calculated by the information output unit 170.

The information output unit 170 displays the initial cost described above.

The information output unit 170 displays the operation cost per product described above.

The information output unit 170 calculates the total cost and displays the total cost.

The total cost is the total of the device durability cost, the property initial cost, and the manufacturing cost per product.

The device durability cost is the total sum of the durability cost of each manufacturing device 231 and the durability cost of each carrier device 241.

The durability cost of the manufacturing device 231 is calculated by calculating [235A]×([228]/[238B]).
[235A] is the initial cost 235A.
[228] is the continuation time 228.
[238B] is the durability time 238B.

The durability cost of the carrier device 241 is calculated by calculating [245A]×([228]/[248B]).
[245A] is the initial cost 245A.
[248B] is the durability time 248B.

The property initial cost is the total sum of the initial costs 264 A of each property 261.

The manufacturing cost per product is calculated by multiplying the operation cost per product by a line lifetime manufacturing amount.

The line lifetime manufacturing amount is the number of products 221 to be manufactured over a lifetime on a designed line, and is input to the design automation system 100 by the designer.

The information output unit 170 calculates a total cost per product, and displays the total cost per product.

The total cost per product is calculated by dividing the total cost by the line lifetime manufacturing amount.

The information output unit 170 displays the risk information 268 on each property 261.

The information output unit 170 displays the legal information 269 on each property 261.

Each comparison information is modified in conjunction with update of a database.

The total cost can be displayed in a graphical form. In the graph, the horizontal axis indicates the line lifetime manufacturing amount and the vertical axis indicates the total cost.

In the calculation of the initial cost and the total cost, the device initial cost (235A, 245A) may be reduced according to the remaining number of devices (236, 246) or an owned property. The owned property is determined by referring to the owned information 265 on each property 261.

### Effects of Embodiment 1

According to Embodiment 1, it is possible to design a factory in consideration of a property where the factory will be located and a supplier of a material.

### Supplement to Embodiment 1

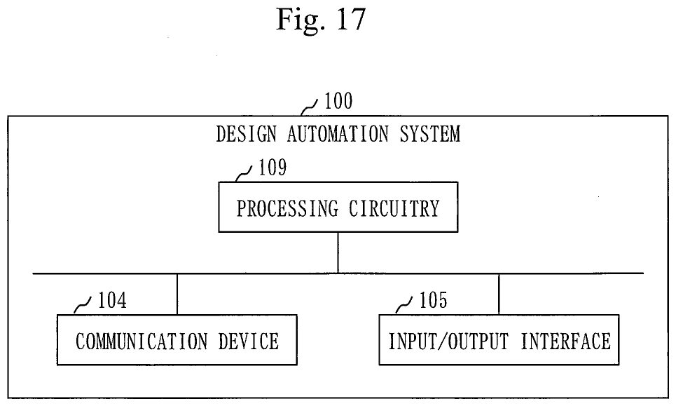

A hardware configuration of the design automation system 100 will be described based on FIG. 17.

The design automation system 100 includes processing circuitry 109.

The processing circuitry 109 is hardware that realizes the information reception unit 110, the purchase number calculation unit 120, the line candidate derivation unit 130, the surplus ratio calculation unit 140, the supplier candidate derivation unit 150, the property candidate derivation unit 160, and the information output unit 170.

The processing circuitry 109 may be dedicated hardware, or may be the processor 101 that executes programs stored in the memory 102.

When the processing circuitry 109 is the dedicated hardware, the processing circuitry 109 is, for example, a single circuit, a composite circuit, a programmed processor, a parallel-programmed processor, an ASIC, an FPGA, or a combination thereof.

ASIC is an abbreviation for Application Specific Integrated Circuit.

FPGA is an abbreviation for Field Programmable Gate Array.

The design automation system 100 may include a plurality of processing circuitry as an alternative to the processing circuitry 109.

In the processing circuitry 109, some functions may be realized by dedicated hardware, and the remaining functions may be realized by software or firmware.

In such a manner, the function of the design automation system 100 can be realized by hardware, software, firmware, or a combination thereof.

Embodiment 1 is an example of a preferred embodiment and is not intended to limit the technical scope of the present disclosure. Embodiment 1 may be implemented partially or may be implemented in combination with another embodiment. The procedures described using the flowcharts or the like may be modified as appropriate.

The design automation system 100 may be realized by a plurality of devices. Each database may be managed by a separate device, for example.

“Unit” of each of the elements of the design automation system 100 may be interpreted as “process”, “step”, “circuit”, or “circuitry”.

### REFERENCE SIGNS LIST

100: design automation system; 101: processor; 102: memory; 103: auxiliary storage device; 104: communication device; 105: input/output interface; 109: processing circuitry; 110: information reception unit; 120: purchase number calculation unit; 130: line candidate derivation unit; 140: surplus ratio calculation unit; 150: supplier candidate derivation unit; 160: property candidate derivation unit; 170: information output unit; 190: storage unit; 210: product DB; 211: product; 212: manufacturing flow; 213: material; 214: purchase amount; 215: production amount; 216: initial budget; 217: operation budget; 220: delivery destination DB; 221: product; 222: delivery destination; 223: location; 224: number of deliveries; 225: carrier container; 226: postponement time; 227: transportation time; 228: continuation time; 230: manufacturing device DB; 231: manufacturing device; 232A: function; 232B: product object; 232C: production amount; 233A: carry-in information; 233B: carry-out information; 234: dimension information; 235A: initial cost; 235B: operation cost; 236: remaining number of devices; 237: resource consumption amount; 238A: preparation time; 238B: durability time; 240: carrier device DB; 241: carrier device; 242B: carrier object; 242C: carrier amount; 243A: carry-in information; 243B: carry-out information; 244: dimension information; 245A: initial cost; 245B: operation cost; 246: remaining number of devices; 247: resource consumption amount; 248A: preparation time; 248B: durability time; 250: supplier DB; 251: material; 252: supplier; 253: location; 254: purchasable amount; 255: purchase price; 256: preparation time; 257: transportation time; 260: real estate DB; 261: property; 262: location; 263: dimension information; 264A: initial cost; 264B: operation cost; 265: owned information; 266: resource price; 267: preparation time; 268: risk information; 269: legal information; 270: transportation DB; 271: transportation object; 272: transportation amount.

1. A design automation apparatus comprising:
processing circuitry:
to refer to a product database that stores product information including information indicating a manufacturing flow of a product and information indicating a material used in the manufacturing flow, and a manufacturing device database that stores manufacturing device information including information indicating a function of each manufacturing device, to derive as a line candidate, a combination of manufacturing devices that realizes one or more tasks included in the manufacturing flow;
to refer to the product database, a supplier database that stores supplier information including information indicating each supplier of a material, and a delivery destination database that stores delivery destination information including information indicating a delivery destination of the product, to derive as a supplier candidate, a supplier that is close to the delivery destination;
to refer to the delivery destination database and a real estate database that stores real estate information indicating each property, to derive as a property candidate, a property that is close to the delivery destination and the supplier candidate; and
to output information on a candidate set which is a set of the line candidate, the supplier candidate, and the property candidate.

2. The design automation apparatus according to claim 1, wherein
the processing circuitry calculates as a logistics center of gravity, a point of center of gravity of the delivery destination and the supplier candidate, and derives as the property candidate, a property that is close to the logistics center of gravity.

3. The design automation apparatus according to claim 1, wherein
the manufacturing device information includes information indicating a floor area of the manufacturing device, and
the processing circuitry calculates a necessary floor area for each line candidate, selects as a smallest line candidate, a line candidate whose necessary floor area is the smallest, and outputs information on a candidate set including the smallest line candidate.

4. The design automation apparatus according to claim 2, wherein
the manufacturing device information includes information indicating a floor area of the manufacturing device, and
the processing circuitry calculates a necessary floor area for each line candidate, selects as a smallest line candidate, a line candidate whose necessary floor area is the smallest, and outputs information on a candidate set including the smallest line candidate.

5. The design automation apparatus according to claim 1, wherein
the manufacturing device information includes information indicating a carry-in method of an object to the manufacturing device and information indicating a carry-out method of an object from the manufacturing device, and
the processing circuitry refers to a carrier device database that stores carrier device information including information indicating a carry-in method of an object to each carrier device and information indicating a carry-out method of the object from each carrier device, selects a carrier device that is necessary between a manufacturing device at the upstream and a manufacturing device at the downstream when the carry-out method of the manufacturing device at the upstream and the carry-in method of the manufacturing device at the downstream are not consistent, and adds the selected carrier device to the line candidate.

6. The design automation apparatus according to claim 5, wherein
the manufacturing device information includes information indicating a floor area of the manufacturing device,
the carrier device information includes information indicating a floor area of the carrier device, and
the processing circuitry calculates a floor area necessary for each line candidate, selects as a smallest line candidate, a line candidate whose necessary floor area is the smallest, and outputs information on a candidate set including the smallest line candidate.

7. The design automation apparatus according to claim 2, wherein
the manufacturing device information includes information indicating a carry-in method of an object to the manufacturing device and information indicating a carry-out method of an object from the manufacturing device, and
the processing circuitry refers to a carrier device database that stores carrier device information including information indicating a carry-in method of an object to each carrier device and information indicating a carry-out method of the object from each carrier device, selects a carrier device that is necessary between a manufacturing device at the upstream and a manufacturing device at the downstream when the carry-out method of the manufacturing device at the upstream and the carry-in method of the manufacturing device at the downstream are not consistent, and adds the selected carrier device to the line candidate.

8. The design automation apparatus according to claim 7, wherein
the manufacturing device information includes information indicating a floor area of the manufacturing device,
the carrier device information includes information indicating a floor area of the carrier device, and
the processing circuitry calculates a floor area necessary for each line candidate, selects as a smallest line candidate, a line candidate whose necessary floor area is the smallest, and outputs information on a candidate set including the smallest line candidate.

9. The design automation apparatus according to claim 1, wherein
the manufacturing device information is stored in the manufacturing device database from a database published on a network,
the supplier information is stored in the supplier database from a database published on a network, and
the real estate information is stores in the real estate database from a database published on a network.

10. The design automation apparatus according to claim 2, wherein
the manufacturing device information is stored in the manufacturing device database from a database published on a network,
the supplier information is stored in the supplier database from a database published on a network, and
the real estate information is stores in the real estate database from a database published on a network.

11. The design automation apparatus according to claim 3, wherein
the manufacturing device information is stored in the manufacturing device database from a database published on a network,
the supplier information is stored in the supplier database from a database published on a network, and
the real estate information is stores in the real estate database from a database published on a network.

12. The design automation apparatus according to claim 4, wherein
the manufacturing device information is stored in the manufacturing device database from a database published on a network,
the supplier information is stored in the supplier database from a database published on a network, and
the real estate information is stores in the real estate database from a database published on a network.

13. The design automation apparatus according to claim 5, wherein
the manufacturing device information is stored in the manufacturing device database from a database published on a network,
the supplier information is stored in the supplier database from a database published on a network, and
the real estate information is stores in the real estate database from a database published on a network.

14. The design automation apparatus according to claim 6, wherein
the manufacturing device information is stored in the manufacturing device database from a database published on a network,
the supplier information is stored in the supplier database from a database published on a network, and
the real estate information is stores in the real estate database from a database published on a network.

15. The design automation apparatus according to claim 7, wherein
the manufacturing device information is stored in the manufacturing device database from a database published on a network,
the supplier information is stored in the supplier database from a database published on a network, and
the real estate information is stores in the real estate database from a database published on a network.

16. The design automation apparatus according to claim 8, wherein
the manufacturing device information is stored in the manufacturing device database from a database published on a network,
the supplier information is stored in the supplier database from a database published on a network, and
the real estate information is stores in the real estate database from a database published on a network.

17. A design automation system comprising:
a product database that stores product information including information indicating a manufacturing flow of a product and information indicating a material used in the manufacturing flow;
a manufacturing device database that stores manufacturing device information including information indicating a function of each manufacturing device;
a supplier database that stores supplier information including information indicating each supplier of a material;
a delivery destination database that stores delivery destination information including information indicating a delivery destination of the product;
a real estate database that sores real estate information indicating each property;
processing circuitry:
to refer to the product database and the manufacturing device database to derive as a line candidate, a combination of manufacturing devices that realizes one or more tasks included in the manufacturing flow;
to refer to the product database, the supplier database, and the delivery destination database to derive as a supplier candidate, a suppler that is close to the delivery destination;
to refer to the delivery destination database and the real estate database to derive as a property candidate, a property that is close to the delivery destination and the supplier candidate; and
to output information on a candidate set which is a set of the line candidate, the supplier candidate, and the property candidate.

18. A design automation method comprising:
referring to a product database that stores product information including information indicating a manufacturing flow of a product and information indicating a material used in the manufacturing flow, and a manufacturing device database that stores manufacturing device information including information indicating a function of each manufacturing device, to derive as a line candidate, a combination of manufacturing devices that realizes one or more tasks included in the manufacturing flow;
referring to the product database, a supplier database that stores supplier information including information indicating each supplier of a material, and a delivery destination database that stores delivery destination information including information indicating a delivery destination of the product, to derive as a supplier candidate, a supplier that is close to the delivery destination;
referring to the delivery destination database and a real estate database that stores real estate information indicating each property, to derive as a property candidate, a property that is close to the delivery destination and the supplier candidate; and
outputting information on a candidate set which is a set of the line candidate, the supplier candidate, and the property candidate.
